(19) United States
(12) Patent Application Publication
(10) Pub. No.: US 2025/0168659 A1
(43) Pub. Date: May 22, 2025

(54) METHOD AND APPARATUS FOR REMOVING CHANNEL NOISE IN WIRELESS COMMUNICATION SYSTEM

(71) Applicant: ELECTRONICS AND TELECOMMUNICATIONS RESEARCH INSTITUTE, Daejeon (KR)

(72) Inventors: Jihyung KIM, Daejeon (KR); Junghyun KIM, Daejeon (KR)

(73) Assignee: ELECTRONICS AND TELECOMMUNICATIONS RESEARCH INSTITUTE, Daejeon (KR)

(21) Appl. No.: 18/948,997

(22) Filed: Nov. 15, 2024

(30) Foreign Application Priority Data
Nov. 16, 2023 (KR) 10-2023-0159313
Nov. 13, 2024 (KR) 10-2024-0161315

(51) Int. Cl. H04W 24/02; H04L 5/00; H04W 76/20

(52) U.S. Cl. CPC H04W 24/02; H04L 5/0051; H04W 76/20

(57) ABSTRACT

The present disclosure relates to a technique for removing channel noise in a wireless communication system. A method of a UE may comprise: configuring a local AI model for channel noise cancellation of the UE based on an initial global AI model for channel noise cancellation; training the local AI model using local data received from a base station; generating local AI model update information based on the training of the local AI model; transmitting, to the base station, a first message including the local AI model update information; and receiving, from the base station, a first global AI model obtained by updating the initial global AI model.

### CROSS-REFERENCE TO RELATED APPLICATIONS

This application claims priority to Korean Patent Applications No. 10-2023-0159313, filed on Nov. 16, 2023, and No. 10-2024-0161315, filed on Nov. 13, 2024, with the Korean Intellectual Property Office (KIPO), the entire contents of which are hereby incorporated by reference.

### BACKGROUND

### 1. Technical Field

The present disclosure relates to a technique for cancelling channel noise in a wireless communication system, and more particularly, to a technique for cancelling channel noise using artificial intelligence (AI)/machine learning (MIL) models.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

Meanwhile, wireless communication systems can be designed considering various scenarios, service requirements, and potential system compatibility. In particular, in the 5G NR communication systems, discussions on beam-based communication are actively underway to enable broadband communication in high-frequency bands. The beam-based communication, which is being discussed in the 5G NR systems, is expected to continue being utilized. Furthermore, when artificial intelligence (AI)/machine learning (ML) is applied to wireless communication systems, the performance of parts where AI/ML is applied can be improved. To date, the 5G NR systems have not presented AI/ML methods for canceling channel noise.

Therefore, AI/ML methods for canceling channel noise in wireless communication systems are required.

### SUMMARY

The present disclosure for resolving the above-described problems is directed to providing a method and apparatus for cancelling channel noise using AI/ML techniques in a wireless communication system.

A method of a user equipment (UE), according to an exemplary embodiment of the present disclosure for achieving the above-described objective, may comprise: configuring a local AI model for channel noise cancellation of the UE based on an initial global AI model for channel noise cancellation; training the local AI model using local data received from a base station; generating local AI model update information based on the training of the local AI model; transmitting, to the base station, a first message including the local AI model update information; and receiving, from the base station, a first global AI model obtained by updating the initial global AI model, wherein the first message may include at least one of information on the initial global AI model, the local AI model update information, or hyperparameters related to the global AI model and the local AI model.

The information on the initial global AI model may be received from the base station when the UE initially accesses the base station.

The local data may include data and reference signals (RSs) preconfigured for training the local AI model.

The training of the local AI model may be performed when the UE is in either an idle state or an inactive state.

The method may further comprise: transmitting, to the base station, a second message including additional information, wherein the additional information may include at least one of information on a data transmission environment, transport block size (TBS) information, modulation coding scheme index (MCS) information, location information of the UE, altitude information of the UE, movement speed information of the UE, trajectory information of the UE, information on a movement of the UE over time, quality of service (QoS) information, power information of the UE, buffer information of the UE, or UE capability information of the UE.

The method may further comprise: transmitting, to the base station, a third message including performance monitoring information of a channel noise canceller using the first global AI model, wherein the performance monitoring information may include at least one of a signal to interference plus noise ratio (SINR), a reference signal received power (RSRP), a hypothetical block error rate (BLER), throughput, or reliability information on an output of a channel noise canceller using the first global AI model.

The method may further comprise: cancelling channel noise using the first global AI model when receiving data from the base station; demodulating and decoding the data from which the channel noise has been cancelled; feeding back a response signal based on a result of the demodulating and decoding to the base station; and in response to receipt of an instruction to stop using the first global AI model from the base station. stopping use of the first global AI model.

The method may further comprise: receiving, from the base station, a training instruction message for the initial global AI model; configuring the initial global AI model as the local AI model of the UE; training the local AI model using the local data; generating the local AI model update information based on the training of the local AI model; and transmitting a fourth message including the local AI model update information to the base station.

The method may further comprise: in response to receipt of an instruction to stop using the first global AI model from the base station, stopping use of the first global AI model; receiving, from the base station, a training instruction message for the initial global AI model; configuring the initial global AI model as the local AI model of the UE; training the local AI model using the local data; generating the local AI model update information based on the training of the AI local model; and in response to the generated local AI model update information being equal to or less than a preset reliability threshold, configuring not to transmit the first message to the base station.

A method of a base station, according to an exemplary embodiment of the present disclosure for achieving the above-described objective, may comprise: transmitting an initial global AI model for channel noise cancellation to each of UEs when the UEs initially access the base station; transmitting preconfigured local data to the UEs; receiving, from each of the UEs, a first message including local AI model update information; generating a first global AI model by updating the initial global AI model based on the first messages; and transmitting information on the first global AI model to the UEs, wherein the first message may include at least one of information on the initial global AI model, the local AI model update information, or hyperparameters related to the initial global AI model and the local AI model. The local data may include data and reference signals (RSs) preconfigured for training the local AI model.

The method may further comprise: receiving, from each of the UEs, a second message including additional information, wherein the additional information may include at least one of information on a data transmission environment, transport block size (TBS) information, modulation coding scheme index (MCS) information, location information of each of the UEs, altitude information of each of the UEs, movement speed information of each of the UEs, trajectory information of each of the UEs, information on a movement of each of the UEs over time, quality of service (QoS) information, power information of each of the UEs, buffer information of each of the UEs, or UE capability information of each of the UEs.

The method may further comprise: receiving, from each of the UEs, a third message including performance monitoring information of a channel noise canceller using the first global AI model, wherein the performance monitoring information may include at least one of a signal to interference plus noise ratio (SINR), a reference signal received power (RSRP), a hypothetical block error rate (BLER), throughput, or reliability information on an output of the channel noise canceller using the first global AI model.

The method may further comprise: transmitting, to each of the UEs, downlink data corresponding to each of the UEs; receiving, from each of the UEs, a feedback signal corresponding to the downlink data; and in response to a preset number or more of the feedback signals including a negative acknowledgement (NACK), transmitting a fourth message instructing the UEs to stop using the first global AI model.

The fourth message may further include instruction information that instructs to perform training using the initial global AI model.

A user equipment (UE), according to an exemplary embodiment of the present disclosure for achieving the above-described objective, may comprise at least one processor, wherein the at least one processor causes the UE to perform: configuring a local AI model for channel noise cancellation of the UE based on an initial global AI model for channel noise cancellation; training the local AI model using local data received from a base station; generating local AI model update information based on the training of the local AI model; transmitting, to the base station, a first message including the local AI model update information; and receiving, from the base station, a first global AI model obtained by updating the initial global AI model, wherein the first message includes at least one of information on the initial global AI model, the local AI model update information, or hyperparameters related to the global AI model and the local AI model.

The information on the initial global AI model may be received from the base station when the UE initially accesses the base station.

The at least one processor may further cause the UE to perform: transmitting, to the base station, a second message including additional information, wherein the additional information may include at least one of information on a data transmission environment, transport block size (TBS) information, modulation coding scheme index (MCS) information, location information of the UE, altitude information of the UE, movement speed information of the UE, trajectory information of the UE, information on a movement of the UE over time, quality of service (QoS) information, power information of the UE, buffer information of the UE, or UE capability information of the UE.

The at least one processor may further cause the UE to perform: transmitting, to the base station, a third message including performance monitoring information of a channel noise canceller using the first global AI model, wherein the performance monitoring information may include at least one of a signal to interference plus noise ratio (SINR), a reference signal received power (RSRP), a hypothetical block error rate (BLER), throughput, or reliability information on an output of a channel noise canceller using the first global AI model.

The at least one processor may further cause the UE to perform: cancelling channel noise using the first global AI model when receiving data from the base station; demodulating and decoding the data from which the channel noise has been cancelled; feeding back a response signal based on a result of the demodulating and decoding to the base station; and in response to receipt of an instruction to stop using the first global AI model from the base station. stopping use of the first global AI model.

According to exemplary embodiments of the present disclosure, AI/ML can be applied to a channel noise canceller in a wireless communication system. This can enhance channel noise cancellation performance during communication between a base station and a terminal.

Additionally, a local AI model for channel noise cancellation corresponding to each terminal can be used depending on a channel environment between the base station and the terminal, thereby improving channel noise cancellation performance tailored to the individual channel environment of each terminal. Furthermore, when channel noise cancellation efficiency deteriorates or communication quality degrades, a global AI model can be updated, and the local AI models can be reconfigured based on the updated global AI model to improve noise cancellation performance. Moreover, during updates of the global AI model, a ratio of values applied to the global AI model for each terminal can be determined based on performance monitoring information provided by the terminals. This provides the advantage of performing more accurate updates of the global AI model.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating a functional framework for RAN intelligence using artificial intelligence (AI)/machine learning (ML).

FIG. 4 is a conceptual diagram illustrating a transmitter, receiver, and channel for describing a noise pre-cancellation operation in a wireless channel of a wireless network.

FIG. 5 is a conceptual diagram illustrating generation of a global model and training of a local model based on federated learning in a RAN.

FIG. 6 is a conceptual diagram illustrating a structure of a transceiver including a channel noise canceller, when training data and pilot signals are used together for local model training in an OFDM system.

FIG. 7 is a sequence chart illustrating a procedure between a base station and terminals when updating a global model based on federated learning.

FIG. 8 is a conceptual diagram for describing an update procedure of a global model and local model based on basic information.

FIG. 9 is a conceptual diagram for describing an update procedure of a global model and a local model based on basic information and additional information.

FIG. 10 is another conceptual diagram for describing an update procedure of a global model and a local model based on basic information and additional information.

FIG. 11 is another conceptual diagram for describing an update procedure of a global model and a local model based on basic information and additional information.

FIG. 12 is a flowchart illustrating an operation of a terminal when configuring a local model based on a global model and updating the global model.

FIG. 13 is a flowchart illustrating an operation of a base station for deploying and updating a global model.

FIG. 14 is a flowchart illustrating an operation of a base station when updating an initial global model based on federated learning.

### DETAILED DESCRIPTION OF THE EMBODIMENTS

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g. 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

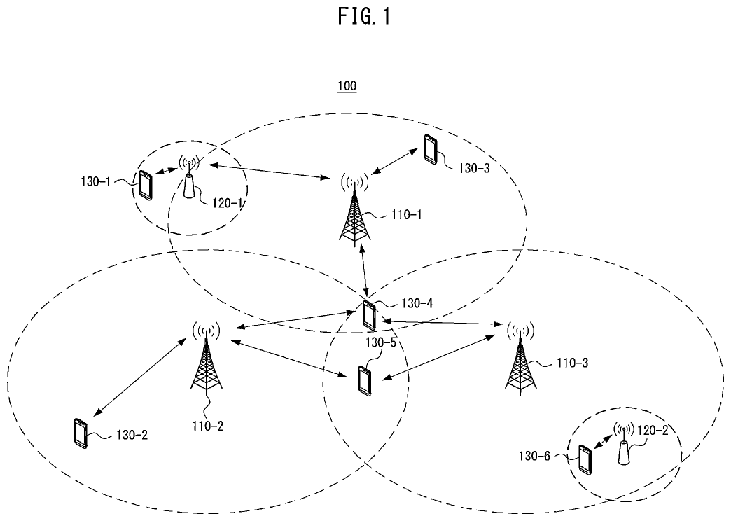

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network. When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

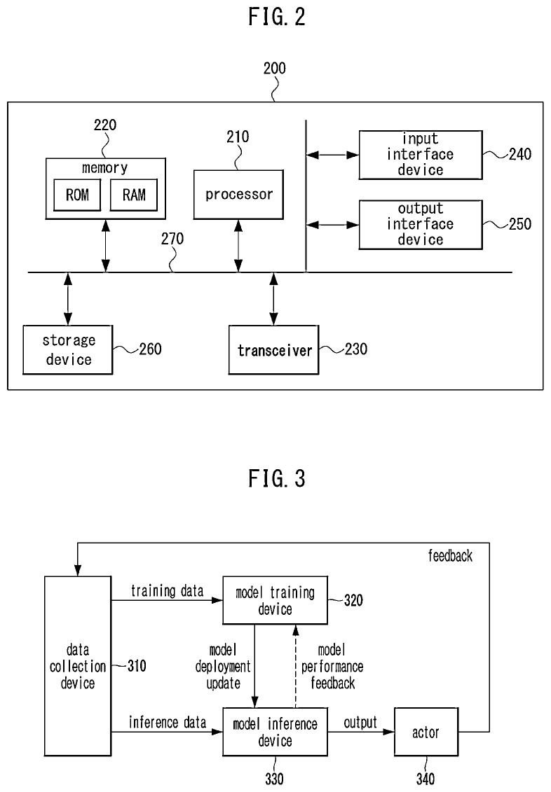

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B (NB), evolved Node-B (eNB), gNB, base transceiver station (BTS), radio base station, radio transceiver, access point, access node, road side unit (RSU), radio remote head (RRH), transmission point (TP), transmission and reception point (TRP), or the like.

Each of the plurality of terminals 130-1, 130-2, 130-3, 130-4, 130-5, and 130-6 may refer to a user equipment (UE), terminal, access terminal, mobile terminal, station, subscriber station, mobile station, portable subscriber station, node, device, Internet of Thing (IoT) device, mounted module/device/terminal, on-board device/terminal, or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5, or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g. a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMNO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods for configuring and managing radio interfaces in a communication system will be described. Even when a method (e.g. transmission or reception of a signal) performed at a first communication node among communication nodes is described, the corresponding second communication node may perform a method (e.g. reception or transmission of the signal) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g. remote radio transmission/reception function, baseband processing function, and the like) of a communication protocol. Alternatively, the remote radio transmission/reception function among all the functions of the communication protocol may be performed by a transmission and reception point (TRP) (e.g. flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

FIG. 3 is a conceptual diagram illustrating a functional framework for RAN intelligence using artificial intelligence (AI)/machine learning (ML).

Referring to FIG. 3, a functional framework for radio access network (RAN) intelligence using artificial intelligence (AI)/machine learning (ML) may include a data collection device 310, a model training device 320, a model inference device 330, and an actor 340. In the following description, AI/ML may refer to either AI alone or ML alone. However, such references are for convenience of description and should be understood as encompassing both AI and/or ML regardless of whether only AI or ML is specified.

The data collection device 310 may be a device that collects data for updating an AI model through offline and/or online schemes. Although FIG. 3 does not illustrate an offline scheme for collecting data to update the AI model, the data collection device 310 may receive offline data from an operator, an external device, or a separate network. The example shown in FIG. 3 illustrates a procedure in which the data collection device 310 receives feedback information from the actor 340 through an online scheme.

The data collection device 310 may be an entity that provides input data to the model training device 320 and the model inference device 330. The data input by the data collection device 310 to the model training device 320 and the model inference device 330 may be data classified from offline data and/or online data, as described above. The online data may include at least one of feedback values from another entity within the network, such as the actor 340, and feedback values regarding outputs of the AI/ML model.

More specifically, the data provided by the data collection device 310 to the model training device 320 may be training data. The training data may be data provided for training of the AI/ML model. Inference data provided by the data collection device 310 to the model inference device 330 may be data provided for performing inference using the AI/ML model.

The model training device 320 may be an entity that performs training, validation, and/or testing of the AI/ML model. The model training device 320 may generate performance metrics for the AI/ML model through training, validation, and testing. The model training device 320 may update the AI/ML model based on the generated performance metrics. In other words, the model training device 320 may provide the updated AI/ML model to the model inference device 330 through a model deployment update procedure.

The model inference device 330 may infer a performance of the AI/ML model provided by the model training device 320 and may provide a result to the model training device 320 through a model performance feedback procedure. When inferring the performance of the AI/ML model provided by the model training device 320, the model inference device 330 may perform the inference by using the inference data provided by the data collection device 310. The procedure in which the model inference device 330 provides feedback on the AI/ML model's performance to the model training device 320 may optionally be used. It should be noted that the model performance feedback in FIG. 3 is represented with a dotted line to indicate that the feedback procedure is optional. However, the present disclosure assumes a case in which model performance feedback is performed.

The model training device 320 may further perform training, validation, and/or testing of the AI/ML model based on the performance of the AI/ML model provided to the model inference device 330, which is obtained through the model performance feedback procedure. The model training device 320 may additionally generate performance metrics for the AI/ML model through training, validation, and testing. The model training device 320 may update the AI/ML model again based on the additionally generated performance metrics. Then, the model training device 320 may provide the updated AI/ML model again to the model inference device 330.

Meanwhile, the model inference device 330 may receive inference data from the data collection device 310 and may perform inference using the AI/ML model provided by the model training device 320. If the AI/ML model provided by the model training device 320 is determined to be appropriate based on an inference result, the model inference device 330 may provide (or output) the AI/ML model to the actor 340.

The actor 340 may be communication node(s) constituting the functional framework for RAN intelligence using AI/ML. As another example, the actor 340 may be a specific device to which the AI/ML model is applied. For example, the actor 340 may be a channel noise canceller described later in the present disclosure. As another example, the actor 340 may be a device that generates feedback information based on the output of the channel noise canceller described later in the present disclosure.

The actor 340 may operate by applying the received AI/ML model and may provide an operation result as feedback information to the data collection device 310.

In general, in the RAN, since the AI/ML model is provided by the base station to the terminal, the actor 340 may be assumed to be the terminal. Additionally, the remaining components excluding the actor 340 among the components shown in FIG. 3 may be located in the base station and/or in a higher-level network including the base station.

As described above with reference to FIG. 3, the training (or learning) of the AI/ML model may be performed using training data in the model training device 320. The AI/ML model trained in the model training device 320 may be provided to the model inference device 330. The model inference device 330 may perform inference on the AI/ML model trained using inference data provided by the data collection device 310 and may provide an inference result as feedback to the model training device 320 through the model performance feedback procedure. Accordingly, the model training device 320 may reflect the inference result to further update the AI/ML model and may provide the updated AI/ML model again to the model inference device 330.

The model inference device 330 may perform inference using the updated AI/ML model based on inference data again, and if an inference result is determined to be appropriate, the model inference device 330 may provide the updated AI/ML model to the actor 340. The actor 340 may apply the updated AI/ML model. The actor 340 may apply the AI/ML model in an actual communication environment and may provide a result as feedback to the data collection device 310. This procedure may be performed iteratively. Therefore, the AI/ML model may be continuously updated.

The form in which the AI/ML model is applied in the RAN, described in FIG. 3, may vary. For example, the data collection device 310, the model training device 320, and the model inference device 330 may be included in the base station, and the actor 340 may be included in the terminal. As another example, the data collection device 310, the model training device 320, and the model inference device 330 may be included in a higher-level network that includes the base station (or a separate network for providing AI/ML data), and the actor 340 may be included in the terminal. As yet another example, the data collection device 310, the model training device 320, the model inference device 330, and the actor 340 may each be included in both the base station and the terminal.

The base station may perform measurement on beams to be allocated to the terminal based on the AI/ML model. In such cases, inference data input to the model inference device 330 may include candidate beam information, beam measurement information, the terminal's movement path information, and/or other information. Based on the inference data, the model inference device 330 may determine suitability of the AI/ML model. The actor 340, to which the AI/ML model selected according to the determination is applied, may provide feedback on results of the AI/ML model's application.

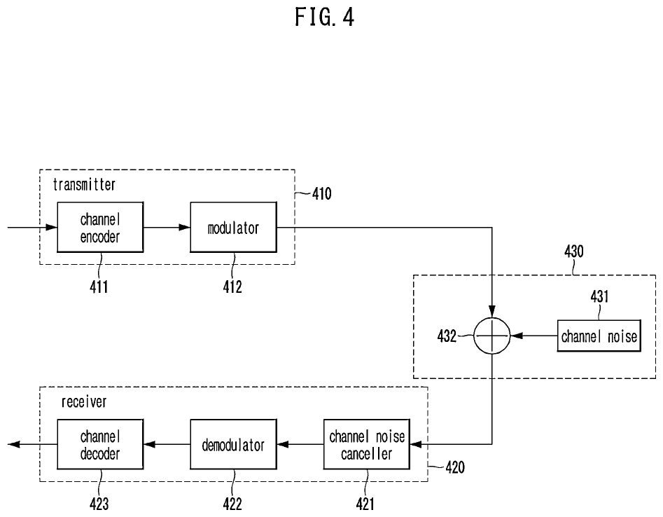

FIG. 4 is a conceptual diagram illustrating a transmitter, receiver, and channel for describing a noise pre-cancellation operation in a wireless channel of a wireless network.

Referring to FIG. 4, a transmitter 410, a receiver 420, and a wireless channel 430 are illustrated.

The transmitter 410 may include a channel encoder 411 and a modulator 412. Additionally, the receiver 420 may include a channel noise canceller 421, a demodulator 422, and a channel decoder 423. The wireless channel 430 is simply modeled as an adder 432, where one of its inputs is represented by channel noise 431. Those skilled in the art will understand that the transmitter 410 and receiver 420 illustrated in FIG. 4 are simplified examples for signal transmission and reception. The transmitter 410 and/or receiver 420 may include all or at least part of the components described in FIG. 2. Furthermore, the components illustrated in FIG. 4 may correspond to a part of components of the transceiver 230 in FIG. 2. The transmitter 410 and/or receiver 420 may include additional components as well as those illustrated in FIG. 2. For example, they may further include the components for AI/ML described in FIG. 3. As a noise cancellation operation in a wireless channel will be described below, descriptions on additional components of FIG. 4 are omitted.

The channel encoder 411 of the transmitter 410 may perform channel encoding on data to be transmitted and provide channel-encoded symbols to the modulator 412. The modulator 412 may modulate the channel-encoded symbols to generate modulated symbols. The modulated symbols generated by the modulator 412 may be transmitted to the receiver 420 through the wireless channel 430.

In the present disclosure, the wireless channel 430 may be in a form where only the channel noise 431 is considered. Generally, the channel noise 431 may be understood as being added to a transmitted signal. Accordingly, the wireless channel 430 is illustrated in a simplified form where the channel noise 431 is added to the signal transmitted by the transmitter 410 through the adder 432. For example, if the signal transmitted by the transmitter 410 is denoted as x and the channel noise 431 as n, the signal y transmitted through the wireless channel 430 may be expressed as ‘y=x+n’.

The receiver 420 may receive the signal with the channel noise 431 added to the modulated symbols. The channel noise canceller 421 of the receiver 420 may cancel the channel noise 431 from the received signal and provide the processed signal to the demodulator 422. The demodulator 422 may demodulate the signal from which the channel noise 431 has been canceled. The demodulator 422 may provide the demodulated symbols to the channel decoder 423. The channel decoder 423 may perform channel decoding to retrieve the transmitted data. In other words, the receiver 420 may cancel the noise present in the wireless channel 430 through the channel noise canceler 421 before demodulating the signal using the demodulator 422. Through the above-described process, the receiver 420 may improve reception performance, such as a block error rate, during the demodulation and decoding process.

In an exemplary embodiment, a neural network model related to the channel noise 431 may be pre-updated in an ideal additive white Gaussian noise (AWGN) channel environment through offline training. AWGN represents ideal noise with a uniform distribution across all frequency bands in a wireless communication system. The channel noise canceler 421 may apply the neural network model (e.g. AI/ML model) updated through offline training. The neural network updated through offline training may improve channel noise performance in the wireless channel environment based on the trained model.

For example, in the case where the neural network model applied to the channel noise canceler 421 is trained through offline training, it may be assumed that virtual data is transmitted for the offline training of the neural network model applied to the channel noise canceler 421. The virtual data may undergo channel encoding by the channel encoder 411 and modulation by the modulator 412 as in a transmission process by the transmitter 410, as illustrated in FIG. 4. Additionally, noise may be added to the modulated virtual data to generate a signal with added noise.

The neural network model applied to the channel noise canceler 421 may be trained by using the signal with added noise as input. To describe the operation of the neural network model applied to the channel noise canceler 421 in more detail, y may be assumed to represent the signal transmitted from the transmitter 410 without noise, and y′ may be assumed to represent the signal transmitted from the transmitter 410 with added noise.

The neural network model may be trained to minimize a difference between y and y′. The neural network model trained through the training process may be applied to the channel noise canceler 421. Therefore, the receiver 420 may cancel noise from the received signal through the channel noise canceller 421 before performing demodulation and decoding.

The AWGN described above may represent ideal noise. Since the neural network model is trained based on AWGN, differences may exist between the actual wireless channel and the AWGN environment. For example, the actual wireless channel may include not only noise but also various channel effects and interference. Therefore, when the channel noise canceler 421 with the AI/ML model trained using AWGN is applied to the actual wireless environment, performance degradation may occur.

Additionally, the transmitter 410 may transmit a transport block (TB) to the receiver 420, with its size varying depending on a wireless channel environment. When the size of the TB varies, the transmitter 410 may use a different channel encoding scheme and/or modulation scheme for the transmitted TB. Thus, it may be necessary to design a channel noise canceler model tailored to the transmission environment.

Moreover, in the wireless communication system, the wireless channel environment between a terminal and the base station may differ for each terminal. The actual wireless channel environment experienced by the terminal may also be limited. In such cases, it is necessary to train the neural network model applied to the channel noise canceler 421 considering conditions of each terminal. However, performing online training for the AI/ML model included in the channel noise canceller 421 may encounter limitations.

In the present disclosure described below, methods are described for designing a channel noise canceler with superior performance in an actual wireless channel environment by applying federated learning (FL)-based online training, addressing the limitations mentioned earlier.

The federated learning may be a training scheme based on a global model and a local model. In the present disclosure, the global model may refer to an AI/ML model generated at a base station and/or a specific server in the network and provided to terminals. Additionally, the local model may refer to an AI/ML model applied by each terminal after receiving the global model. In the present disclosure, both the global model and local model may be trained.

For convenience of description, the following description assumes that the global model is generated and maintained by the base station. However, the global model may also be generated by a specific server in the network and maintained by that server. As another example, the global model may be generated by a specific server in the network but maintained by another server. In yet another example, the global model may be generated by a specific server in the network but maintained by the base station.

Furthermore, for convenience of description, the following description assumes that a device with the local model is a terminal, for example, a user equipment (UE).

The base station may generate a federated learning-based global model and may deliver the generated global model to each device (e.g. terminal). Each terminal may generate a local model based on the received global model and may train the local model using local data. Once the local model is trained, the terminal may transmit update information of the local model (i.e. local model update information) to the base station. The base station may obtain the local model update information from each terminal and update the global model based thereon. The base station may then deliver the updated global model again to each terminal.

For example, a new communication system (e.g. 6G communication system) may apply federated learning and federated learning model parameters based on federated learning. The federated learning model parameters may be parameters related to the global model and the local model, and may not be limited to a specific form.

As described above, the wireless channel environment experienced by each terminal may vary. A flexible channel noise cancelling scheme may be necessary, considering the environment of each terminal. To address this, the present disclosure describes a case where the federated learning scheme is applied.

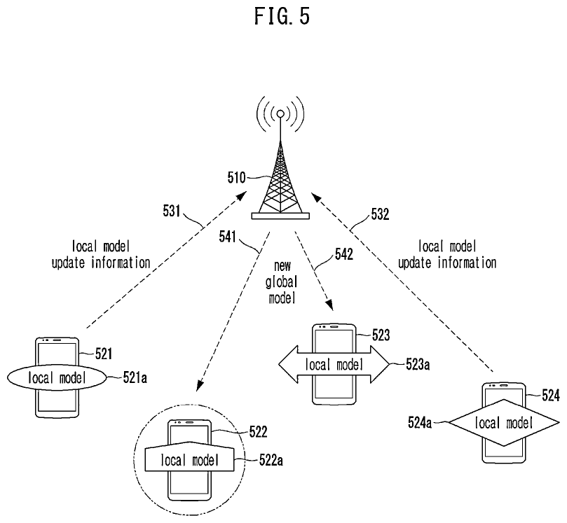

FIG. 5 is a conceptual diagram illustrating generation of a global model and training of a local model based on federated learning in a RAN.

Referring to FIG. 5, a base station 510 may communicate with multiple terminals 521, 522, 523, and 524. Thus, the multiple terminals 521, 522, 523, and 524 may each be located within a cell coverage of the base station 510.

The base station 510 may generate a global model based on federated learning. Here, the global model may be a global AI model or a global ML model for channel noise cancelation. In the following description, the global model may refer to a global AI or ML model for channel noise cancelation and may be referred to as the global model for convenience.

Each of the terminals 521, 522, 523, and 524 may access the base station 510 to perform communication. When each of the terminals 521, 522, 523, and 524 accesses the base station 510, each of the terminals may obtain an initial global model for channel noise cancelation from the base station 510. The initial global model may refer to the global model for which online training has not been performed. In other words, the initial global model may refer to the global model that has undergone offline training, as described earlier in FIG. 4.

When the base station 510 provides the initial global model to the terminals 521, 522, 523, and 524, various methods may be used. As a method for the base station 510 to deliver the initial global model to the terminals 521, 522, 523, and 524, at least one of the following methods may be used.

First, the base station 510 may transmit the initial global model for channel noise cancellation itself to each of the terminals 521, 522, 523, and 524. In other words, the base station 510 may transmit all the information of the initial global model to each of the terminals 521, 522, 523, and 524.

The first method described above requires transmitting a large amount of information because the base station 510 transmits the initial global model itself to each of the terminals 521, 522, 523, and 524. However, the amount of information that each of the terminals 521, 522, 523, and 524 is able to receive during the access process with the base station 510 may have limitations. Therefore, the second method described below may also be used.

Second, when each of the terminals 521, 522, 523, and 524 initially accesses the base station 510, the base station 510 may provide information on parameters for the initial global model for channel noise cancellation. Accordingly, each of the terminals 521, 522, 523, and 524 may obtain information on parameters for the initial global model for channel noise cancellation from the base station. For the second method to be applied, both the base station 510 and each of the terminals 521, 522, 523, and 524 may need to have at least one pre-stored global model for channel noise cancellation. Accordingly, the base station 510 may configure and indicate parameters specifying a global model for channel noise cancellation to be used, which is selected from the pre-stored global models, to each of the terminals 521, 522, 523, and 524.

Third, each of the terminals 521, 522, 523, and 524 and the base station 510 may have one pre-stored global model for channel noise cancellation. When each of the terminals 521, 522, 523, and 524 accesses the base station 510, the base station 510 may transmit parameters indicating whether to use the global model for channel noise cancellation.

In the case of the third method, the base station 510 may perform training of the global model for channel noise cancellation based on federated learning. To perform training of the global model, the base station 510 may obtain local model update information from each of the terminals 521, 522, 523, and 524. To this end, the base station 510 may instruct each of the terminals 521, 522, 523, and 524 to use the global model for channel noise cancellation and to report (or provide feedback on) the local model update information. When the base station 510 obtains the local model update information from each of the terminals 521, 522, 523, and 524, the base station 510 may perform updates to the global model for channel noise cancellation.

Once the base station 510 performs updates to the global model based on federated learning, the base station 510 may perform communication with each of the terminals 521, 522, 523, and 524. During communication using the updated global model, the base station 510 and each of the terminals 521, 522, 523, and 524 may not perform updates to the global model based on federated learning. For example, updates to the global model based on federated learning may be performed based on a preconfigured cycle. Updates to the global model based on federated learning may also be performed only at pre-determined times and/or under specific conditions. For example, updates to the global model based on federated learning may be performed during periods of low communication traffic or when the terminals are in an idle state. The updates to the global model based on federated learning may also occur in other cases.

As described earlier, the global model may be generated and deployed by the base station 510 so that all terminals 521, 522, 523, and 524 commonly use the global model. One or two or more initial global models may exist.

For example, the initial global model may be identically determined for all base stations. As another example, the initial global model may be separately determined for multiple base station groups. As yet another example, the initial global model may be determined for each terminal group according to various factors such as the locations or environments of terminals within a single base station.

The cases where the initial global model is determined for each terminal group may be as follows.

The base station 510 may group one or more terminals based on location information of terminals. In other words, one group may include one or more terminals, and the number of groups may be two or more. Therefore, the base station 510 may allocate an initial global model to each group. Here, the initial global model allocated to each group may reflect characteristics of the group. The characteristics of the group may be determined based on factors such as a channel environment experienced by the group, surrounding environmental information, movement speed of terminals of the group, and/or movement direction of terminals of the group. In the present disclosure, the factors that determine each group characteristic are described as one example, and various methods may be applied to distinguish groups according to the present disclosure.

The base station 510 may determine an area or cell to allocate the same initial global model. The base station 510 may provide the same initial global model to terminals belonging to a specific area or a specific cell. When a group is determined based on a specific area or cell where the same initial global model is applied, a group to which a terminal belongs may change according to movement of the terminal. For example, a first cell (or first area) may be assumed as a first group, and a second cell (or second area) may be assumed as a second group. In this case, when a terminal belonging to the first cell (or first area) moves to the second cell (second area), the base station 510 may update the initial global model based on the terminal's location information and/or movement information. In other words, the base station 510 may instruct the terminal that moved from the first cell to the second cell to release the existing global model based on the terminal's movement information, and may allocate a new global model to the terminal. The terminal, when allocated the new global model, may generate a local model based on the new global model and perform channel noise cancellation based on the newly generated local model. The terminal that moved to the second cell and uses the new local model may contribute to updating the global model through local model updates as described above.

A local model described below may refer to a local AI model for channel noise cancellation or a local ML model for channel noise cancellation. In the following description, for convenience, it will be referred to as a local model.

Hereinafter, a method by which the terminal contributes to updating the global model through local model updates will be described.

The base station 510 may transmit an initial global model to the terminal when the terminal initially accesses a cell. The terminal may determine (or generate) a local model based on the initial global model received from the base station 510. The terminal may perform training based on the determined (or generated) local model, and may update the local model based on the training. Then, the terminal may transmit the updated local model to the base station 510. The base station 510 may update the global model based on the updated local models obtained from the respective terminals. Thereafter, the base station 510 may deploy the updated global model again to each of the terminals 521, 522, 523, and 524. Each of the terminals 521, 522, 523, and 524 may perform channel noise cancellation based on the deployed global model. In addition, each of the terminals 521, 522, 523, and 524 may determine a local model based on the updated global model, perform training, and transmit information on the updated local model again to the base station 510. The above-described procedure may be performed iteratively.

Meanwhile, the information transmitted during global model download and/or local model information upload may include information on a model structure and hyperparameters. The model structure and hyperparameters may be encoded as binary data or text-formatted data for transmission. The hyperparameters may be parameters for defining configurable parts of the training process of the global model or local model. The hyperparameters may include model hyperparameters (e.g. topology and size of a neural network) and/or algorithm hyperparameters (e.g. training rate of an optimizer and batch size).

The training of the local model at the terminal may be performed when communication is inactive. For example, the terminal may request permission from the base station 510 to perform local model training when no data is being transmitted. The base station 510 may indicate to the terminal whether to allow local model training if the terminal requests local model training. If local model training is allowed, the base station 510 may transmit training data to the terminal based on predefined rules. If the base station 510 has data to transmit to the terminal or is currently engaged in data transmission, the base station 510 may reject the terminal's request for local model training, A representative case where the terminal is not communicating may include when the terminal is in an idle mode or when the terminal is in an inactive mode. In any of these cases, the terminal may transmit a local model training request to the base station 510. Additionally, the local model training request may be determined based on factors such as a remaining battery level of the terminal and/or a necessity of local model training.

The target of the local model training according to the present disclosure may be the local model for channel noise cancellation. The terminal may train the local model for channel noise cancellation to cancel channel noise based on data known in advance and data received from the base station 510. For example, local model training may involve updating weights, bias values, and other predefined hyperparameters of the neural network that constitutes the channel noise canceller.

During the local model training, the terminal may use reference signals used for channel estimation instead of training data. Alternatively, the terminal may use both data known in advance and reference signals together for local model training.

When the terminal performs local model training using at least one of the methods described above, the terminal may transmit update information based on the local model training to the base station 510. The update information may include difference values compared to the existing hyperparameter values. By transmitting the difference values compared to the existing hyperparameter values, the terminal may reduce the amount of data traffic transmitted to the base station 510. Accordingly, the terminal may calculate the difference values compared to the existing hyperparameter values and configure the calculated difference values as the update information.

The base station 510 may instruct multiple terminals 521, 522, 523, and 524 to perform local model training simultaneously to reduce the amount of data transmission required for local model training. Therefore, the base station 510 may transmit the data required for local model training to multiple terminals 521, 522, 523, and 524 at the same time. Here, the same time may correspond to a local model training period configured by the base station 510. The base station 510 may transmit information on the configured period to the multiple terminals 521, 522, 523, and 524 in advance. Alternatively, the base station 510 may instruct terminals participating in the federated learning of the global model to perform local model training when the configured period arrives. Additionally, the base station 510 may determine a reception time for receiving update information from terminals that have performed local model training. The base station 510 may indicate the reception time for receiving the update information to the terminals that performed the local model training. Furthermore, the base station 510 may control a channel environment to receive the update information from the terminals that performed local model training. For example, the channel environment may be controlled by allocating channels with minimal interference signals or providing transmission power control information to the terminals.

The base station 510 may obtain the update information simultaneously from multiple terminals that participated in local model training, preventing delays in training. For example, if one or more terminals among the multiple terminals fail to transmit update information, the base station 510 may update the global model based on the information obtained from the remaining terminals, excluding the update information from the terminals that failed to transmit.

When the base station 510 updates the global model, the base station 510 may transmit the updated global model again to the terminals. Each terminal may perform a channel noise cancellation operation based on the updated global model.

In FIG. 5, the first terminal 521 has a first local model 521a, the second terminal 522 has a second local model 522a, the third terminal 523 has a third local model 523a, and the fourth terminal 524 has a fourth local model 524a. Even when the same global model is received, the respective local models 521a, 522a, 523a, and 524a may be configured differently through local model updates according to the conditions of the respective terminals.

Also, in FIG. 5, reference numerals 531 and 532 illustrate a case where local model update information is reported to the base station 510. Reporting of the local model update information may be configured by the base station 510 as described above. The base station 510 may update the global model based on the received local model update information. The base station 510 may transmit the updated global model, that is, a new global model, to the terminals. In the example of FIG. 5, the base station 510 provides the new global model to the second terminal 522 and the third terminal 532. In other words, reference numerals 541 and 542 illustrate a case where the base station 510 provides the new global model to the second terminal 522 and the third terminal 532.

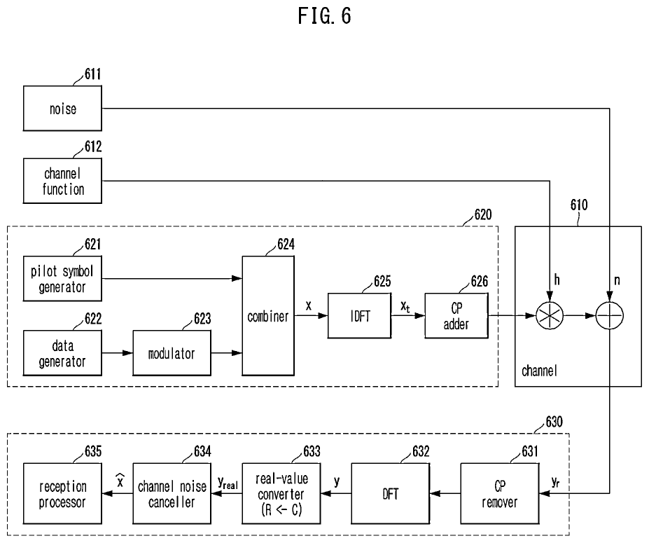

FIG. 6 is a conceptual diagram illustrating a structure of a transceiver including a channel noise canceller, when training data and pilot signals are used together for local model training in an OFDM system.

Referring to FIG. 6, in an orthogonal frequency division multiplexing (OFDM) system, a transmitter 620, a receiver 630, and a channel 610 are illustrated.

The channel 610 may be modeled with a noise 611 and an adder where noise is added, as described in FIG. 4. Additionally, the channel 610 may be modeled as further including a multiplier where a channel function 612 and a signal transmitted from the transmitter 620 are multiplied.

First, a configuration of the transmitter 620 will be described. The transmitter 620 may include a pilot symbol generator 621, a data generator 622, a modulator 623, a combiner 624, an inverse discrete-time Fourier transformer (IDFT) 625, and a cyclic prefix (CP) adder 626.

The pilot symbol generator 621 may generate pilot symbols and provide them to the combiner 624. Additionally, the data generator 622 may generate data to be transmitted and provide it to the modulator 623. The modulator 623 may modulate the data to be transmitted and provide modulated data symbols to the combiner 624. The combiner 624 may combine the pilot symbols and the modulated data symbols in the frequency domain and output a result. In FIG. 6, the output of the combiner 624 is expressed as x, and it may be a signal in which the pilot symbols and data symbols are combined in the frequency domain. The IDFT 625 may transform the frequency domain signal into a time domain signal and output a result. Therefore, the output of the IDFT 625 is expressed as xₜ, which may represent values that vary over time t.

The CP adder 626 may add and concatenate the last part of an OFDM symbol to its head. Here, the OFDM symbol may refer to an OFDM symbol within a fast Fourier transform (FFT) window. The CP adder 626 may determine a CP length differently depending on a numerology used in the OFDM system. The symbols output from the CP adder 626 may be transmitted to the receiver 630 through the channel 610.

The channel 610 may process the symbols output from the transmitter 620 by multiplying them with the channel function 612. As described above, the channel function 612, represented as h, may be a function expressing a wireless channel model excluding noise in the time domain. The symbols output from the transmitter 620, after being multiplied by the channel function, may have the noise 611 added to them. The noise 611, as described above, may be represented as n. Accordingly, the symbols output from the transmitter 620 may take a form of being multiplied by the channel function h and then having the noise n added. Assuming the signal output from the transmitter 620 is x, a signal received by the receiver 630, yᵣ, may be expressed as shown in Equation 1.

$${y}_{r} = h ( x ) + n \qquad [ Equation 1 ]$$

The receiver 630 may include a CP remover 631, a discrete Fourier transformer (DFT) 632, a real-value converter 633, a channel noise canceller 634, and a reception processor 635.

The signal received at the receiver 630 may be expressed as yᵣ, as described in Equation 1. The received signal yᵣ may be a time domain signal. The CP remover 631 may remove a part corresponding to the CP length added by the transmitter 620 from the received signal yᵣ in the OFDM signal. Since the received signal is a time domain signal, the CP remover 631 may remove a part corresponding to the CP length in the time domain. The DFT 632 may perform a discrete Fourier transform on the CP-removed signal to transform it into a frequency domain signal. Accordingly, the signal output from the DFT 632, y, may be a frequency domain signal. The real-value converter 633 may convert the complex value, expressed as y in the frequency domain, into two real numbers.

The channel noise canceller 634 may cancel channel noise from the signal, converted into two real numbers, by using the channel noise cancellation AI/ML model according to the present disclosure. In FIG. 6, the signal with channel noise canceled using the channel noise cancellation AI/ML model is expressed as \hat{x}. The reception processor 635 may comprise devices that perform reception signal processing after a demodulator (not shown in FIG. 6).

The transmitter 620 and receiver 630 illustrated in FIG. 6 may form a part of the transceiver 230 described in FIG. 2. However, if the transmitter 620 is included in the base station, the receiver 630 may be included in the terminal, and if the transmitter 620 is included in the terminal, the receiver 630 may be included in the base station.

Meanwhile, as described above, once local model training is completed, the terminal may upload update information of the trained local model for channel noise cancellation to the base station. Here, the update information of the local model for channel noise cancellation may include weights, bias values, and other values of a neural network constituting the channel noise canceller 634. As another example, the update information of the local model for channel noise cancellation may include difference values before and after the update, as described above. In another example, the update information of the local model for channel noise cancellation may be compressed into quantized information and then transmitted to the base station.

When the base station receives update information of the local model for channel noise cancellation from multiple terminals participating in federated learning, the base station may perform an update of the global model. During the update of the global model, the base station may calculate an average value of the local model update values received from the multiple terminals. Then, the base station may update the previous value of the global model based on the calculated average value. In this case, the update of the previous global model may involve adding the difference between the previous global model value and the calculated average value to the previous global model, or replacing the previous global model value with the calculated average value.

After updating the global model, the base station may deploy the updated global model again to the terminals. The terminals may receive the global model from the base station. When the terminals subsequently receive data from the base station, the terminals may use the global model to cancel noise and then perform demodulation and decoding processes to obtain the data. Through this, the terminals may improve channel noise cancellation performance for received signals.

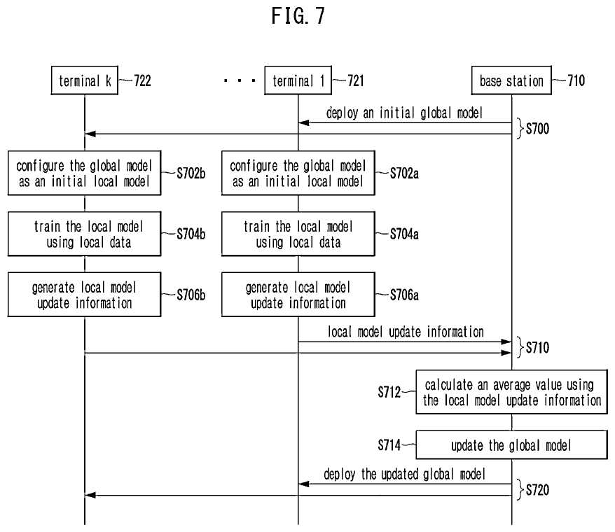

FIG. 7 is a sequence chart illustrating a procedure between a base station and terminals when updating a global model based on federated learning.

Referring to FIG. 7, a base station 710 and terminals 1 to k (i.e. 721 and 722) are illustrated. The base station 710 and the terminals may be communication nodes capable of performing federated learning according to the present disclosure. Each of the base station 710 and terminals 721 to 722 may include all or part of the components illustrated in FIG. 2. At least some of the base station 710 and terminals 721 to 722 may further include additional components as well as those illustrated in FIG. 2. Additionally, the base station 710 may have a global model for channel noise cancellation according to the present disclosure.

In step S700, the base station 710 may transmit an initial global model to each of the multiple terminals 721 to 722. Here, the global model may be a global model for channel noise cancellation. Accordingly, each of the multiple terminals 721 to 722 may receive the global model from the base station 710.

In steps S702a and S702b, each of the multiple terminals 721 to 722 may configure the global model as an initial local model. The multiple terminals 721 to 722 illustrated in FIG. 7 may be terminals determined as belonging to a single group to perform federated learning. As another example, the base station 710 may provide the same global model to all terminals. In this case, the terminals 721 to 722 illustrated in FIG. 7 may be terminals capable of performing federated learning. The exemplary embodiment of FIG. 7, described below, assumes that the multiple terminals 721 to 722 are configured as a single group or all operate based on the same global model. It is also assumed that terminals unable to perform federated learning are not illustrated in FIG. 7.

In steps S704a and S704b, each of the multiple terminals 721 to 722 may train the local model using local data. Each of the multiple terminals 721 to 722 may obtain the local data for local model training. For example, each of the multiple terminals 721 to 722 may obtain the local data considering a wireless channel environment of the terminal. Then, each of the multiple terminals 721 to 722 may perform local model training using the obtained local data. In this case, the training of the local model may be performed using the components of FIG. 3, as described above. Therefore, each of the multiple terminals 721 to 722 may include all the components of FIG. 3. As another example, each of the multiple terminals 721 to 722 may operate as the actor 340 in FIG. 3, and the local model training may be performed by the remaining components of FIG. 3 at the base station 710 and the feedback procedure.

In steps S706a and S706b, each of the multiple terminals 721 to 722 may generate local model update information based on the local model training. As an example, the local model update information may include the entire information of the updated local model. As another example, it may include the difference values between the initial values of the local model and the update values of the updated local model. Additionally, the local model update information may include information on a model structure and hyperparameters, as described earlier in FIG. 5.

In step S710, each of the multiple terminals 721 to 722 may transmit local model update information. In this case, each of the multiple terminals 721 to 722 may transmit the local model update information according to a preset cycle. As another example, each of the multiple terminals 721 to 722 may transmit the local model update information in response to an instruction from the base station 710 (not shown in FIG. 7). Therefore, in step S710, the base station 710 may obtain the local model update information for updating the global model from the multiple terminals 721 to 722.

In this case, if a specific terminal is communicating with the base station 710 or if channel conditions are poor, the local model update information may not be transmitted. As another example, when the base station 710 instructs terminals to transmit the local model update information, the base station 710 may refrain from instructing certain terminals to transmit local model update information, considering an uplink load condition. In other words, the base station 710 may exclude terminals that negatively affect the global model update based on channel conditions or uplink load.

In step S712, the base station 710 may calculate an average value using the local model update information received from the multiple terminals 721 to 722.

In step S714, the base station 710 may update the global model based on the calculated average value. As a method for updating the global model, the base station 710 may add the difference between the previous global model value and the calculated average value to the previous global model, as described above. Alternatively, as another method for updating the global model, the base station 710 may replace the value of the previous global model with the calculated average value.

In step S720, the base station 710 may deploy the updated global model again to the multiple terminals 721 to 722. Therefore, each of the multiple terminals 721 to 722 may receive the updated global model.

Subsequently, each of the multiple terminals 721 to 722 may perform channel noise cancellation using the updated global model. Accordingly, each of the multiple terminals 721 to 722 may cancel channel noise during communication with the base station 710. Through this, the performance of channel noise cancellation can be improved as the global model is updated.

Steps S702a, S702b to S720 illustrated in FIG. 7 may be performed iteratively. The iteration of steps S702a, S702b to S720 may be stopped based on the channel noise cancellation performance. For example, in step S710, the base station 710 may receive local model update information and, in step S712, calculate the difference between the average value of the local model update information received from the multiple terminals 721 to 722 and the currently used global model. In this case, if the average value of the local model update information is smaller than a preset threshold, the base station 710 may not perform steps S714 and S720 (not shown in FIG. 7). Additionally, if the average value of the local model update information is smaller than a preset threshold, the base station 710 may instruct the multiple terminals 721 to 722 to stop transmitting the local model update information (not shown in FIG. 7).

To improve accuracy, the base station 710 may count the number of occurrences where the average value of the local model update information is smaller than the preset threshold. If the counted value reaches a preset number of occurrences, the base station 710 may stop the global model update and/or global model re-deployment procedures, as described above. If the global model update and/or global model re-deployment procedures are stopped, the base station 710 may instruct the multiple terminals 721 to 722 to stop transmitting the local model update information. In this case, the base station may set and indicate a time of stopping the transmission of the local model update information.

### [Method for Downloading a Global Model for Channel Noise Cancellation and Transmitting Local Model Update Information Between a Terminal and a Base Station]

Hereinafter, a procedure and method for downloading a global model for channel noise cancellation from a base station to a terminal, and a procedure and method for updating a local model at the terminal and transmitting local model update information to the base station will be described.

As described above, the base station may provide a global model for channel noise cancellation to the terminal. Accordingly, the terminal may configure the global model provided by the base station as a local model. Then, the terminal may perform training of the local model using local data. Here, the local data may refer to data (or data and reference signals) transmitted and received between the base station and the specific terminal. For example, the local data may be predefined data mutually agreed upon between the base station and the terminal. As another example, the local data may be arbitrary data transmitted and received between the base station and the terminal. The terminal may generate local model update information based on a result of training the local model using the local data. The terminal may transmit the local model update information to the base station.

In the present disclosure, basic information and additional information may be defined as follows. The basic information may also be referred to as primary information, while the additional information may also be referred to as secondary information.
(1) Basic information: Basic information may include at least one of the following.
a) Information on a global model for channel noise cancellation
b) Local model update information
c) Model structure related to the global model and the local model
d) Information on hyperparameters.

The present disclosure describes a federated learning procedure, specifically when the global model for channel noise cancellation and the local model for channel noise cancellation are used. Accordingly, the global model and the local model may be models configured based on federated learning.
(2) Additional information: Additional information may include at least one of the following.
a) Information on a data transmission environment
b) Transport block size (TBS) information
c) Modulation coding scheme (MCS) index information
d) Terminal location information, including a location or altitude of the terminal
e) Terminal movement speed and trajectory information or information on a terminal movement over time
f) Quality of Service (QoS) information
g) Terminal power information
h) Terminal buffer information
i) Terminal capability (UE capability) information

It should be noted that the additional information exemplified above is provided to facilitate understanding and is not limited to the examples given. Accordingly, other information, besides the examples listed above, may also be included in the additional information.

Among the additional information listed above, information on the data transmission environment, MCS information, TBS information, and/or QoS information may be provided either by the base station to the terminal or by the terminal to the base station.

The information on the data transmission environment listed above may be related to a channel noise-based model. Information on the data transmission environment may include the MCS information and TBS information.

Additionally, the terminal location information may be obtained directly by the terminal through a global positioning system (GPS). Accordingly, the terminal location information may be additional information provided by the terminal to the base station. The terminal location information may be managed by a location management function (LMF) entity in the core network. Furthermore, the terminal location information may include an altitude of the terminal, considering satellite communication or unmanned aerial vehicle (UAV)-based communication. The terminal movement speed and trajectory information listed above may be measured as information that varies over time.

The QoS information listed above may be information related to a communication quality of the terminal. The QoS information may represent a minimum QoS required for a service provided to the terminal. As another example, the QoS information may represent an average QoS required for a service provided to the terminal.

The terminal power information listed above may include information on the terminal's power state or power consumption. For example, the terminal's power state may indicate one of a high-power state, middle-power state, or low-power state. For the sake of understanding, the present disclosure defines three states of power levels. However, the power state may be further subdivided. As another example, the terminal power information included as additional information may indicate only the low-power state or an extremely low-power state.

The terminal buffer information may refer to information on buffer(s) related to the terminal's data transmission and/or reception. For example, in the case of data transmission, the buffer information may include a total buffer size allocated to a specific data transmission and a currently available buffer size. As another example for data transmission, the buffer information may include a size of a free buffer space allocated to a specific data transmission. As yet another example, the buffer information may indicate whether a buffer allocated to a specific data transmission has accumulated data exceeding a certain threshold.

The terminal capability information listed above may include information on local AI/ML capabilities. For example, the AI/ML capability information may include at least one of a processing speed of AI/ML, the number of configurable hidden layers of AI/ML, the number of input nodes in an input layer of AI/ML, and/or the number of nodes configurable in the configurable hidden layers of AI/ML.

The additional information described above may relate to the data transmission environment and channel environment rather than being directly related to the federated learning-based model. Furthermore, the additional information may differ for each terminal performing local model training.

In addition, each terminal may experience a different channel environment. Accordingly, the base station may configure the data transmission environment differently based on the channel environment experienced by each terminal. For example, a channel environment experienced by a terminal located in an urban area and a channel environment experienced by a terminal located in a rural area may differ. If the global model update is performed based solely on local model update information without considering the channel environments of terminals in urban or rural areas, a deviation between the models may increase. Considering these factors, the exchange of basic information and additional information may be performed when updating the global model between the base station and terminals.

The base station or terminal may update the global/local model using previously known additional information in addition to the basic information. When performing model updates, expired basic information and/or additional information may be excluded. For example, the base station and terminal may obtain basic information and additional information to update the global model and/or the local model. The updates to the global model and/or local model may need to be performed based on information reflecting current states of the terminal and the base station. If outdated information is continuously reflected, the model updates may fail to represent the current states. Accordingly, the present disclosure proposes configuration of a validity period (or timer) for each piece of basic information and additional information. For example, during the update process for the global model and/or local model, expired information (basic information and/or additional information) that hinders smooth updates may be excluded. In other words, only basic information and/or additional information that reflects the current states of the base station and terminal may be used for global model and/or local model updates.

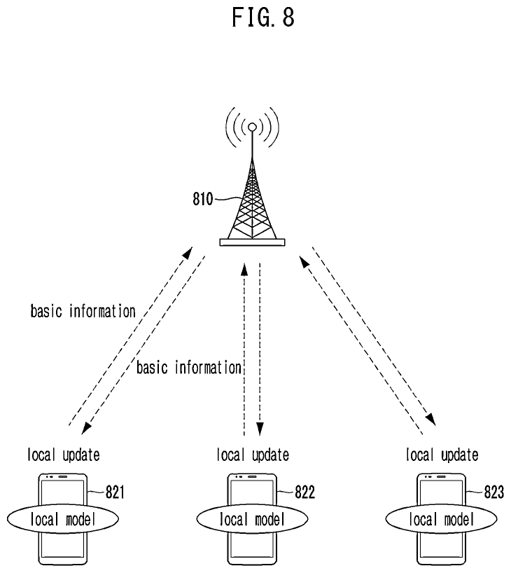

FIG. 8 is a conceptual diagram for describing an update procedure of a global model and local model based on basic information.

Referring to FIG. 8, a base station 810, a first terminal 821, a second terminal 822, and a third terminal 823 are illustrated. The base station 810 may include all or part of the components of the communication node described in FIG. 2. Additionally, the base station 810 may include additional components as well as the components of the communication node described in FIG. 2. For example, the base station 810 may further include interfaces for connecting with neighboring base stations or core network. The base station 810 illustrated in FIG. 8 may also include all or part of the AI/ML RAN components illustrated in FIG. 3.

Each of the terminals 821, 822, and 823 may include all or part of the components of the communication node described in FIG. 2. Additionally, each of the terminals 821, 822, and 823 may include additional components as well as the components of the communication node described in FIG. 2. For example, each of the terminals 821, 822, and 823 may further include interfaces for user convenience or various types of sensors. Each of the terminals 821, 822, and 823 may also include all or part of the AI/ML RAN components illustrated in FIG. 3.

Furthermore, the base station 810 and each of the terminals 821, 822, and 823 may perform federated learning for an AI/ML model according to the present disclosure. As described above, the AI/ML model may be classified into a global model and a local model. Each of the global model and local model may be the AI/ML model for channel noise cancellation according to the present disclosure.

Referring to FIG. 8, the base station 810 may provide the global model to terminals 821, 822, and 823. Accordingly, each of the terminals 821, 822, and 823 may receive the global model from the base station 810. Then, each of the terminals 821, 822, and 823 may train a local model using local data. Furthermore, each of the terminals 821, 822, and 823 may update the local model by reflecting a training result into the local model. Each of the terminals 821, 822, and 823 may transmit basic information to the base station 810 based on the update to the local model, as illustrated in FIG. 8. The basic information may include one or more of the following: information on the global model for channel noise cancellation, local model update information, model structure related to the global and local models, or information on hyperparameters, as described earlier.

FIG. 8 illustrates a case where only basic information is exchanged between the base station 810 and the terminal 821. In other words, the additional information described above may not be transmitted between the base station 810 and the terminal 821 in this case.

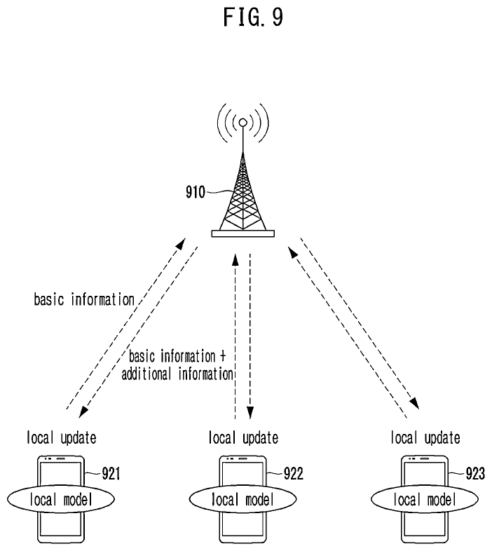

FIG. 9 is a conceptual diagram for describing an update procedure of a global model and a local model based on basic information and additional information.

Referring to FIG. 9, a base station 910, a first terminal 921, a second terminal 922, and a third terminal 923 are illustrated. The base station 910 and the terminals 921, 922, and 923 illustrated in FIG. 9 may correspond to the base station 810 and the terminals 821, 822, and 823 described in FIG. 8, respectively. Therefore, each of the base station 910 and the terminals 921, 922, and 923 may perform federated learning for an AI/ML model. The AI/ML model may be classified into a global model and a local model, and each of the global model and the local model may be the AI/ML model for channel noise cancellation.

Referring to FIG. 9, the base station 910 may provide the global model to the terminals 921, 922, and 923. Accordingly, each of the terminals 921, 922, and 923 may receive the global model from the base station 910. Each of the terminals 921, 922, and 923 may train a local model using local data. Each of the terminals 921, 922, and 923 may update the local model by reflecting a training result of the local model. Each of the terminals 921, 922, and 923 may transmit basic information to the base station 910, as illustrated in FIG. 9, based on the update of the local model. The basic information may include at least one of information on the global model for channel noise cancellation, local model update information, and information on the model structure or hyperparameters related to the global model and the local model, as described above.

Meanwhile, the base station 910 may provide basic information and additional information to the terminals 921, 922, and 923. Therefore, when each of the terminals 921, 922, and 923 obtains the global model from the base station 910, the terminal may additionally receive the additional information as well as the basic information. In other words, the base station 910 may provide the additional information when transmitting the global model to each of the terminals 921, 922, and 923, in addition to the basic information. Each of the terminals 921, 922, and 923 may generate local data using the basic information and the additional information obtained when receiving the global model. Each of the terminals 921, 922, and 923 may train the local model based on the local data derived from the additional information. In this case, the additional information may include at least one of information on a data transmission environment, MCS information, TBS information, or QoS information.

Each of the terminals 921, 922, and 923 may generate local model update information reflecting the additional information. Each of the terminals 921, 922, and 923 may transmit the local model update information to the base station 910. Since the example of FIG. 9 corresponds to a case where the terminal transmits only the basic information, the base station 910 may update the global model based on the local model update information received from each of the terminals 921, 922, and 923.

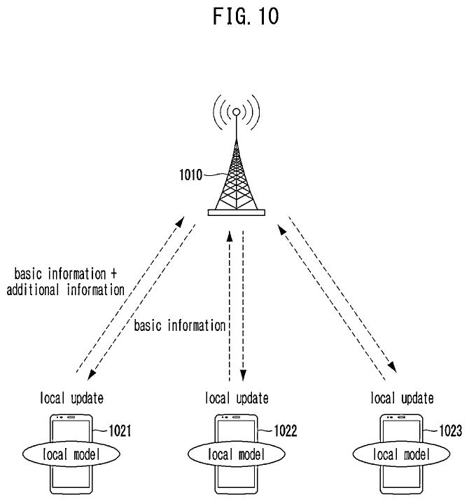

FIG. 10 is another conceptual diagram for describing an update procedure of a global model and a local model based on basic information and additional information.

Referring to FIG. 10, a base station 1010, a first terminal 1021, a second terminal 1022, and a third terminal 1023 are illustrated. The base station 1010 and the terminals 1021, 1022, and 1023 illustrated in FIG. 10 may correspond to the base station 810 and the terminals 821, 822, and 823 described in FIG. 8, respectively. Therefore, each of the base station 1010 and the terminals 1021, 1022, and 1023 may perform federated learning for an AI/ML model. The AI/ML model may be classified into a global model and a local model, and each of the global model and the local model may be the AI/ML model for channel noise cancellation.

The case of FIG. 10 may correspond to the opposite case of FIG. 9 described earlier. In other words, the base station 1010 may provide basic information to the terminals 1021, 1022, and 1023, and each of the terminals 1021, 1022, and 1023 may additionally provide additional information to the base station 1010.

The base station 1010 may provide the global model to the terminals 1021, 1022, and 1023. In this case, information on the global model may be configured as basic information and provided to the terminals 1021, 1022, and 1023. Accordingly, each of the terminals 1021, 1022, and 1023 may receive the global model, configured as the basic information, from the base station 1010. Each of the terminals 1021, 1022, and 1023 may train a local model using local data. Each of the terminals 1021, 1022, and 1023 may update the local model by reflecting a training result of the local model. Each of the terminals 1021, 1022, and 1023 may transmit update information of the local model configured as basic information to the base station 1010, as illustrated in FIG. 10. Each of the terminals 1021, 1022, and 1023 may also transmit additional information to the base station 1010.

The additional information may include at least one of information on a data transmission environment, TBS information, MCS information, terminal location information (or terminal location information including an altitude), terminal movement speed and direction (trajectory) information (or information on the terminal's movement over time), QoS information, terminal power information, terminal buffer information, or terminal capability information, as described earlier.

Therefore, the base station 1010 may receive the basic information, including local model update information, and the additional information from the terminals 1021, 1022, and 1023. When updating the global model based on the local model update information, the base station 1010 may consider (or reflect) the additional information received from the terminals 1021, 1022, and 1023 when updating the global model. For example, when the additional information received from the terminals 1021, 1022, and 1023 includes information on the surrounding channel environment and data transmission status, the base station 1010 may update the global model by considering the surrounding channel environment and data transmission status information of each of the terminals 1021, 1022, and 1023.

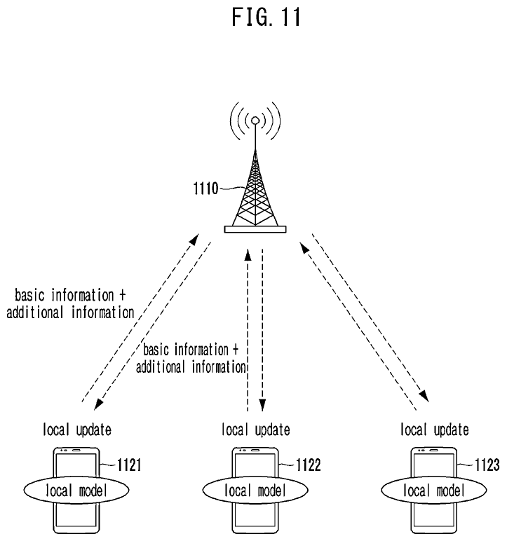

FIG. 11 is another conceptual diagram for describing an update procedure of a global model and a local model based on basic information and additional information.

Referring to FIG. 11, a base station 1110, a first terminal 1121, a second terminal 1122, and a third terminal 1123 are illustrated. The base station 1110 and the terminals 1121, 1122, and 1123 illustrated in FIG. 11 may correspond to the base station 810 and the terminals 821, 822, and 823 described in FIG. 8, respectively. Therefore, each of the base station 1110 and the terminals 1121, 1122, and 1123 may perform federated learning for an AI/ML model. The AI/ML model may be classified into a global model and a local model, and each of the global model and the local model may be the AI/ML model for channel noise cancellation.

The case of FIG. 11 corresponds to a case where both the base station 1110 and the terminals 1121, 1122, and 1123 are able to transmit not only basic information but also additional information. Therefore, the base station 1110 may provide both basic information and additional information to each of the terminals 1121, 1122, and 1123. Each of the terminals 1121, 1122, and 1123 may also provide both basic information and additional information to the base station 1110.

The base station 1110 may provide the global model to the terminals 1121, 1122, and 1123. In this case, information on the global model may be configured as basic information and provided to the terminals 1121, 1122, and 1123. The base station 1110 may also provide additional information to each of the terminals 1121, 1122, and 1123 in addition to the basic information. The basic information provided by the base station 1110 to the terminals 1121, 1122, and 1123 may include at least one of information on the global model for channel noise cancellation, local model update information, and information on a model structure or hyperparameters related to the global model and the local model, as described earlier.

The additional information provided by the base station 1110 to the terminals 1121, 1122, and 1123 may include at least one of information on a data transmission environment, MCS information, TBS information, or QoS information.

Therefore, each of the terminals 1121, 1122, and 1123 may receive the global model, configured as basic information, from the base station 1110 and may further receive the additional information. Each of the terminals 1121, 1122, and 1123 may configure the global model as its local model. Each of the terminals 1121, 1122, and 1123 may train the local model using local data. In this case, each of the terminals 1121, 1122, and 1123 may generate the local data using the additional information received from the base station 1110, and may train the local model of each of the terminals 1121, 1122, and 1123 using the generated local data.

Each of the terminals 1121, 1122, and 1123 may update the local model by reflecting a training result of the local model. Each of the terminals 1121, 1122, and 1123 may transmit update information of the local model, configured as basic information, to the base station 1110, as illustrated in FIG. 11. Each of the terminals 1121, 1122, and 1123 may further transmit additional information to the base station 1110.

The additional information transmitted by each of the terminals 1121, 1122, and 1123 to the base station 1110 may include at least one of information on a data transmission environment, TBS information, MCS information, terminal location information (or terminal location information including an altitude), terminal movement speed and direction (trajectory) information (or information on the terminal's movement over time), QoS information, terminal power information, terminal buffer information, or terminal capability information, as described earlier.

Therefore, the base station 1110 may obtain the basic information, including local model update information, and information related to the environment between the terminal and the base station and/or data transmission. The base station 1110 may update the global model using the local model update information and the additional information. Then, the base station 1110 may transmit the updated global model to each of the terminals 1121, 1122, and 1123.

### [Method for Determining Update of a Global Model]

The above described a method for downloading a global model for channel noise cancellation and transmitting local model update information. Hereinafter, a method for determining whether update of the global model is required will be described.

### (1) Method for Determining Necessity of Global Model Update

The base station may determine whether training of the global model is required. In this case, the determination may be made based on feedback information transmitted by the terminal. For example, the terminal may feedback a response signal corresponding to data received from the base station to provide the validity of the channel noise canceller used by the terminal to the base station. The response signal transmitted by the terminal may be a signal indicating whether demodulation and decoding of the data received from the base station have succeeded. For example, the response signal may be a feedback signal indicating one of a positive acknowledgement (ACK) or a negative acknowledgement (NACK). When the terminal feeds back ACK or NACK as the response signal, the terminal may also transmit information on whether the global model (or the local model used by the terminal based on the global model) is in use to the base station.

Meanwhile, the base station may communicate with terminals belonging to various groups, such as cell-specific groups, distance-based groups, or terminal environment-based groups. In this case, at least one terminal may belong to a group. Therefore, the base station may use different global models for the respective groups. In other words, the base station may use multiple global models. Accordingly, the base station may need to determine whether an update is required for each of the multiple global models.

The base station may use response signals received from terminals to determine whether an update is required for each global model. For example, the base station may count the number of NACK signals among the response signals received from terminals using a specific global model. The base station may then check whether the number of received NACK signals is equal to or greater than a predefined value N. Here, N may be a natural number. If the number of received NACK signals is equal to or greater than the predefined value N, the base station may determine that an update of the corresponding global model is required. On the other hand, if the number of received NACK signals is less than the predefined value N, the base station may determine that an update of the corresponding global model is not required.

The counting of NACK signals may be performed during a predefined time interval. Additionally, the predefined value N may vary depending on the number of communicating terminals. For example, the base station may determine that an update of the corresponding global model is required if NACK signals equal to or greater than N1 are received from 10 terminals within a predetermined interval of Y seconds. As another example, the base station may determine that an update of the corresponding global model is required if NACK signals equal to or greater than N2 are received from 100 terminals within a predetermined interval of Y seconds. In this case, N2 may be set to a value greater than N1. In the above-described manner, for a base station communicating using a specific global model, the reference value N used for comparing with the NACK signal count within the same time interval may be set differently depending on the number of terminals using the corresponding global model.

Additionally, the predefined value Y may also vary. For example, if high-speed data is transmitted between the base station and the terminal, the base station may determine that an update of the corresponding global model is required if NACK signals equal to or greater than N are received within a time interval of Y1 seconds. On the other hand, if low-speed data is transmitted between the base station and the terminal, the base station may determine that an update of the corresponding global model is required if NACK signals equal to or greater than N are received within a time interval of Y2 seconds. In this case, Y1 may be smaller than Y2. The time interval corresponding to Y, which is configured based on the data transmission speed between the base station and the terminal, may vary as described above. Additionally, the time interval corresponding to Y may also vary depending on a distance between the base station and the terminal.

(2) Operation Method when Determined to Update a Global Model

As described above, the base station may determine whether an update of a specific global model is required based on response signals. If an update of the specific global model is required, the base station may instruct all terminals using the corresponding global model to stop using the global model. The base station may also instruct training of a local model along with the instruction to stop using the global model. The local model configured for each terminal may be the global model provided during initial access or may be a local model based on the updated global model received from the base station. Accordingly, when the base station instructs training of the local model, the base station may further instruct whether to perform training based on the current global model or based on the global model received from the base station during initial access.

### (3) Method for Determining a Global Model to be Updated

The global model may be classified into two types. One type may be the initial global model received by the terminal from the base station during initial access. The other type may be the updated global model based on the initial global model. Since the method for updating the global model has already been described above, redundant descriptions are omitted.

The base station may need to determine which model to use for training between the initial global model and the updated global model. In other words, a method may be required for the base station to decide whether to use the initial global model or the currently used global model during training of the global model.

Hereinafter, methods for determining the global model for which training is to be performed according to the present disclosure will be described.

First, the base station may recognize the number of terminals using the same global model. For example, the base station may identify the number of terminals belonging to a first group that uses a first global model. Alternatively, the base station may identify the number of communicating terminals among those belonging to the first group using the first global model. For convenience of description, description below is based on the number of terminals belonging to the first group using the first global model. However, it should be noted that the number of communicating terminals among those belonging to the first group using the first global model may also be used.

The base station may count the number of terminals in the first group using the first global model that transmitted NACK signals within a predefined time. If the number of terminals that transmitted NACK signals is equal to or greater than half of the total number of terminals in the first group, the base station may determine that an error originated from the initial global model. Accordingly, the base station may instruct the terminals in the first group to restart local model training based on values of the initial global model.

On the other hand, if the number of terminals that transmitted NACK signals is less than half of the total number of terminals in the first group, the base station may determine that an error originated from a problem in the most recent local training of individual terminals. Accordingly, the base station may instruct the terminals in the first group to restart local model training based on value of the most recent global model currently in use.

(4) Operation Method of the Base Station and Terminals when a Global Model to be Updated is Determined

As can be understood from the above description, in order to perform the above-described operation, the terminals need to have information on at least three global models. First, the terminal may need to have information on the initial global model received from the base station during initial access. Second, the terminal may need to have information on the global model currently applied and in use. Third, the terminal may need to have information on the global model that was used immediately before the current global model.

If a terminal does not have information on a specific global model among the three described above, the base station may retransmit the corresponding global model information to the terminal. When retransmitting the global model information, if the base station can identify which global models the terminal possesses based on the terminal's capability information, the base station may retransmit only the global models that the terminal does not possess. In another example, the base station may transmit the global model that needs to be trained to the terminal along with a training instruction. Furthermore, if a terminal receiving the training instruction does not have the corresponding global model, the terminal may request retransmission and receive the global model from the base station.

(5) Method for Enhancing Reliability when Updating a Global Model

Hereinafter, methods for enhancing reliability when updating a global model at the base station will be described.

As described above, the terminal may receive the global model and construct (or generate) a local model for each terminal. Here, the local model may be an AI/ML model applied to the channel noise canceller. The terminal may perform channel noise cancellation using the channel noise canceller where the local model is applied. In other words, the terminal may perform AI inference operations based on the local model. Additionally, the terminal may obtain performance monitoring information (or performance monitoring values) for the AI inference.

The performance monitoring information may include at least one of the following information derived based on channel noise cancellation results.
a) Signal-to-interference plus noise ratio (SINR)
b) Reference signal received power (RSRP)
c) Hypothetical block error rate (BLER)
d) Throughput
e) Other performance-related information
f) Reliability information for the AI output based on AI inference.

Here, the reliability information for the AI output may be probability information. The reliability information for the AI output may refer to reliability information for the output of the channel noise canceller where the global model (or a local model based on the global model) is applied.

The terminal may transmit the performance monitoring information based on AI inference to the base station. The performance monitoring information may correspond to additional information among the basic information (or primary information) and additional information (or secondary information) described earlier. The base station may compare the performance monitoring information received from the terminal with predefined information. Here, the predefined information may be determined differently based on information reported from the terminal. For example, when the performance monitoring information includes an SINR value, the predefined information may be an SINR threshold for comparison with the SINR value included in the performance monitoring information. In another example, when the performance monitoring information includes an RSRP value, the predefined information may be an RSRP threshold for comparison with the RSRP value included in the performance monitoring information.

If a specific value included in the performance monitoring information is smaller than the predefined threshold, the base station may exclude the corresponding terminal during global model training or apply a specific weight thereto when updating the global model. In other words, the base station may perform the global model update by considering the specific value included in the performance monitoring information. By using the weight when comparing the value included in the performance monitoring information with the predefined threshold, the accuracy of the global model update can be further improved.

The above describes the method for the base station to enhance reliability when updating the global model based on performance monitoring information received from the terminals. However, the method for improving reliability during the global model update may also be applied at the terminal, not just at the base station.

The terminal may directly determine the reliability of the AI output based on performance monitoring for local training. For example, when the reliability of the AI output is below a predefined threshold, the terminal may decide not to transmit the information for updating the global model to the base station. In other words, the terminal may decide whether to transmit the performance monitoring information to the base station based on the reliability of the AI output. In this case, the base station may provide the predefined threshold to the terminal in advance. Accordingly, the terminal may receive the threshold related to performance monitoring from the base station.

The reliability threshold related to performance monitoring may be transmitted from the base station to the terminal using system information, higher-layer signaling, and the like. Therefore, a time of transmitting the threshold related to performance monitoring may be determined depending on a message used. For example, if the threshold related to performance monitoring is included in system information, the threshold related to performance monitoring may be transmitted from the base station to the terminal at a time of system information transmission. In another example, if the threshold related to performance monitoring is transmitted through higher-layer signaling such as RRC signaling, the threshold related to performance monitoring may be transmitted through an RRC configuration message or an RRC reconfiguration message. It should be noted that these examples of messages are provided for better understanding and are not limited thereto.

Therefore, if there are terminals that did not transmit information for the global model update, the base station may update the global model by excluding those terminals. This can improve the reliability of the global model update.

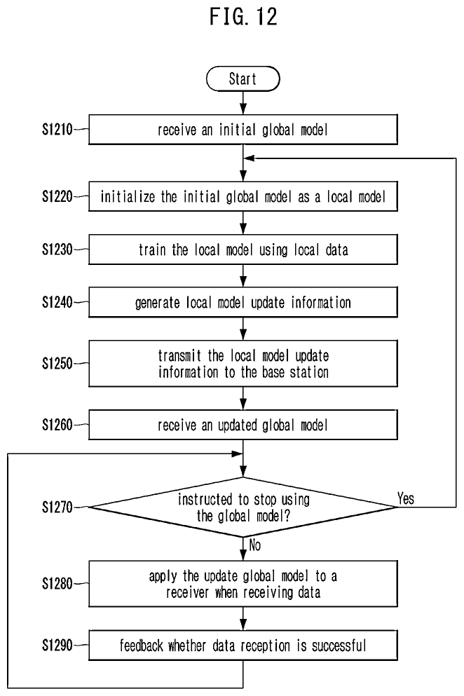

FIG. 12 is a flowchart illustrating an operation of a terminal when configuring a local model based on a global model and updating the global model.

Referring to FIG. 12, in step S1210, the terminal may receive (download) an initial global model from the base station. In other words, the base station may transmit the initial global model to the terminal during initial access of the terminal or when the terminal indicates that application of an AI/ML model to the channel noise canceller according to the present disclosure is possible.

In step S1220, the terminal may initialize the global model received from the base station as a local model.

In step S1230, the terminal may train the local model using local data. The training of the local model using local data may be performed based on the methods described earlier. For example, the terminal may train the local model by receiving data for local model training from the base station, by using the data for local model training along with reference signals, or by using only the reference signals.

In step S1240, the terminal may update the local model based on the local model training. Additionally, the terminal may generate local model update information based on the update of the local model.

In step S1250, the terminal may transmit (upload) the local model update information to the base station. Accordingly, the base station may receive the local model update information. Although FIG. 12 is a flowchart for the operation of the terminal, the operation of the base station is not illustrated. However, a brief description on the base station operation is provided as follows.

The base station may update the global model using the local model update information received from the terminal. In this case, the base station may use local model update information received from multiple terminals, rather than local model update information received from a single terminal. However, if there is only one terminal belonging to a specific group, the base station may update the global model based on the local model update information received from the single terminal in that group. The base station may then apply the updated global model to channel noise cancellation. In other words, the base station may transmit the updated global model to the terminal.

In step S1260, the terminal may receive the updated global model from the base station.

In step S1270, the terminal may identify whether the base station instructs to stop using the global model. As described earlier, if errors in the AI/ML model applied to the channel noise canceller occur beyond a predefined threshold, the base station may instruct to stop using the global model. If the identification in step S1270 determines that the base station instructs to stop using the global model, the terminal may proceed to step S1220. On the other hand, if the base station does not instruct to stop using the global model, the terminal may proceed to step S1280.

In the exemplary embodiment of FIG. 12, a case is illustrated in which the initial global model is used when the use of the global model has been instructed to stop by the base station. However, as described earlier, either the use of the initial global model or the use of the most recent global model may be instructed. If retraining of the most recent global model is required, the flowchart in FIG. 12 may be modified (or adjusted) based on the description provided earlier.

If the base station does not instruct to stop using the global model, the terminal may apply the updated global model when receiving data in step S1280.

In step S1290, the terminal may configure reception success information for the received data or reception failure information as an ACK/NACK response signal and provide feedback to the base station. Based on the reception success information (ACK) or reception failure information (NACK), the base station may determine whether to instruct to stop using the global model.

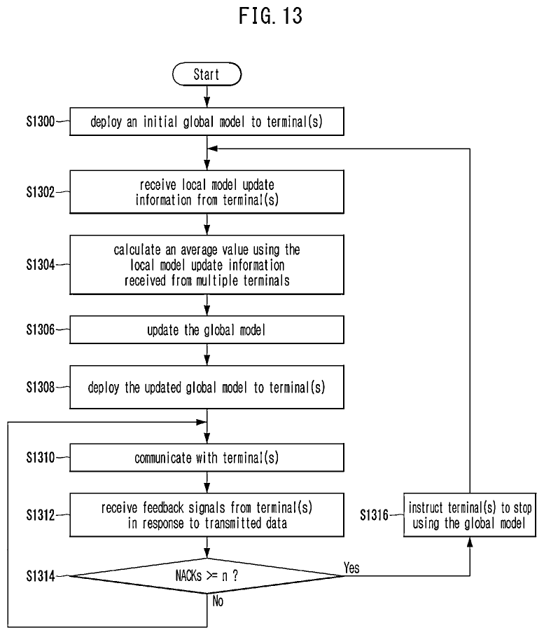

FIG. 13 is a flowchart illustrating an operation of a base station for deploying and updating a global model.

Referring to FIG. 13, in step S1300, the base station may deploy the initial global model to the terminal(s). As described earlier, the initial global model may be deployed based on the terminal capability information during the terminal's initial access. In another example, the initial global model may be deployed at a time when the terminal can apply the AI/ML model to the channel noise canceller.

Therefore, in step S1300, each of the terminal(s) may initialize the received global model as a local model. Each of the terminal(s) may train the local model using local data as described earlier. Each of the terminal(s) may update the local model based on the training of the local model and generate local model update information. Additionally, each of the terminal(s) may transmit the local model update information to the base station.

In step S1302, the base station may receive the local model update information from the terminals. In this case, if the base station manages two or more groups and the global models are differently configured for the respective groups, the base station may receive the local model update information from the terminals belonging to the same group. In other words, if the base station manages two or more groups, the local model update information corresponding to the respective groups may be received from the terminals belonging to the respective groups.

In step S1304, the base station may calculate an average value using the local model update information received from the terminals. In this case, if each terminal provides performance monitoring information as additional information, as described earlier, the base station may calculate the average value by applying weights to the local model update information for the respective terminals based on the performance monitoring information.

In step S1306, the base station may update the global model using the calculated average value.

In step S1308, the base station may deploying the updated global model to the terminals. Accordingly, each terminal may receive the updated global model from the base station and reconfigured the update global model as a local model.

In step S1310, the base station may communicate with the terminals. Terminals that configured the updated global model as the local model in step S1308 may receive data using the channel noise canceller with the configured local model when communicating with the base station. In other words, the terminal may perform channel noise cancellation using the channel noise canceller where the local model based on the updated global model is adopted when communicating with the base station. Additionally, the terminal may generate a response signal for data received from the base station and transmit the generated response signal to the base station. Here, the response signal may be an ACK/NACK, as described earlier.

In step S1312, the base station may receive the feedback, that is, the response signal corresponding to the data transmitted to the terminal.

In step S1314, the base station may count NACKs received from terminals belonging to the same group and identify whether the number of received NACKs is equal to or greater than a predefined value n. Here, the predefined value n may be a threshold set for stopping the use of the global model and retraining the global model.

If the identification in step S1314 determines that the number of NACKs received from terminals belonging to the same group is equal to or greater than the predefined value n, the base station may proceed to step S1316. If the number of NACKs is less than the predefined value n, the base station may proceed to step S1310.

In step S1316, the base station may instruct the terminals to stop using the global model. In this case, the base station may also instruct the terminals to perform retraining based on the initial global model. The base station may then perform step S1302. Additionally, as described earlier in FIG. 12, the flowchart of FIG. 13 provides an example of performing retraining based on the initial global model. If retraining of the most recent global model is required, the flowchart of FIG. 13 may be modified (or adjusted) based on the description provided above.

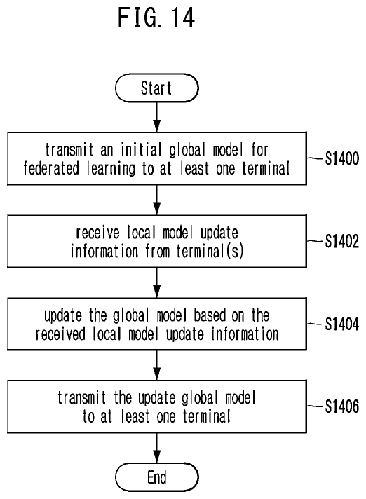

FIG. 14 is a flowchart illustrating an operation of a base station when updating an initial global model based on federated learning.

Referring to FIG. 14, in step S1400, the base station may transmit an initial global model for federated learning to at least one terminal. In this case, if the initial global model for federated learning is configured separately for each group, the initial global model corresponding to the group to which each terminal belongs may be transmitted. Additionally, in step S1400, when transmitting the initial global model to the terminals, the base station may transmit additional information as well. The additional information has been described earlier, and since the operation in which the base station transmits the additional information to the terminal has been described with reference to FIG. 9 and/or FIG. 11, redundant descriptions are omitted.

Based on the transmission of the initial global model in step S1400, each terminal may receive the initial global model. Each terminal may then configure the initial global model as a local model and train the local model using local data. Each terminal may update the local model based on the training of the local model and generate local model update information based on the update of the local model. The terminal may transmit the local model update information to the base station. If necessary, or if instructed by the base station, the terminal may also transmit additional information to the base station. Since the case where the terminal transmits additional information to the base station has been described with reference to FIG. 10 and/or FIG. 11, redundant descriptions are omitted.

In step S1402, the base station may receive the local model update information from the terminals. In this case, the base station may classify the local model update information based on the groups to which the terminals belong. If additional information is also received from the terminals, the base station may map the additional information to the local model update information received as basic information for management purposes.

In step S1404, the base station may update the global model based on the local model update information received from the terminals. If the additional information is also received from the terminals, the base station may consider the additional information when updating the global model.

In step S1406, the base station may transmit the updated global model to the terminals.

The base station may perform channel noise cancellation operations for data to be transmitted based on the updated global model, and at least one terminal may receive the data transmitted from the base station based on the updated global model. Here, when the base station transmits data to at least one terminal, the base station may obtain feedback information from the at least one terminal.

Additionally, the base station may count the number of received negative feedbacks, that is, NACKs, from the terminals and may instruct the terminals using the corresponding global model to stop using the corresponding global model if a predefined condition is exceeded.

When a terminal receives an instruction to stop using the global model, the terminal may reconfigure the local model based on the received initial global model and perform training for the reconfigured local model using local data. Additionally, the terminal may generate local model update information based on the training of the local model and transmit the local model update information to the base station.

The exemplary embodiments of the present disclosure described above have been described as a sequential series of operations for the sake of clarity. However, this should not be understood as limiting the present disclosure. In other words, among the operations described in the present disclosure, some operations may be omitted, performed simultaneously in parallel, or performed in a different order than described. Furthermore, in addition to the operations described above, additional operations may be included and performed within the scope of the present disclosure.

The various exemplary embodiments of the present disclosure do not list all possible combinations but are intended to describe representative aspects of the present disclosure. Therefore, the matters described in the various exemplary embodiments may be applied independently or in combination of two or more.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a user equipment (UE), comprising:
configuring a local artificial intelligence (AI) model for channel noise cancellation of the UE based on an initial global AI model for channel noise cancellation;
training the local AI model using local data received from a base station;
generating local AI model update information based on the training of the local AI model;
transmitting, to the base station, a first message including the local AI model update information; and
receiving, from the base station, a first global AI model obtained by updating the initial global AI model,
wherein the first message includes at least one of information on the initial global AI model, the local AI model update information, or hyperparameters related to the global AI model and the local AI model.

2. The method according to claim 1, wherein the information on the initial global AI model is received from the base station when the UE initially accesses the base station.

3. The method according to claim 1, wherein the local data includes data and reference signals (RSs) preconfigured for training the local AI model.

4. The method according to claim 1, wherein the training of the local AI model is performed when the UE is in either an idle state or an inactive state.

5. The method according to claim 1, further comprising: transmitting, to the base station, a second message including additional information,
wherein the additional information includes at least one of information on a data transmission environment, transport block size (TBS) information, modulation coding scheme index (MCS) information, location information of the UE, altitude information of the UE, movement speed information of the UE, trajectory information of the UE, information on a movement of the UE over time, quality of service (QoS) information, power information of the UE, buffer information of the UE, or UE capability information of the UE.

6. The method according to claim 1, further comprising: transmitting, to the base station, a third message including performance monitoring information of a channel noise canceller using the first global AI model,
wherein the performance monitoring information includes at least one of a signal to interference plus noise ratio (SINR), a reference signal received power (RSRP), a hypothetical block error rate (BLER), throughput, or reliability information on an output of a channel noise canceller using the first global AI model.

7. The method according to claim 1, further comprising:
cancelling channel noise using the first global AI model when receiving data from the base station;
demodulating and decoding the data from which the channel noise has been cancelled;
feeding back a response signal based on a result of the demodulating and decoding to the base station; and
in response to receipt of an instruction to stop using the first global AI model from the base station. stopping use of the first global AI model.

8. The method according to claim 7, further comprising:
receiving, from the base station, a training instruction message for the initial global AI model;
configuring the initial global AI model as the local AI model of the UE;
training the local AI model using the local data;
generating the local AI model update information based on the training of the local AI model; and
transmitting a fourth message including the local AI model update information to the base station.

9. The method according to claim 1, further comprising:
in response to receipt of an instruction to stop using the first global AI model from the base station, stopping use of the first global AI model;
receiving, from the base station, a training instruction message for the initial global AI model;
configuring the initial global AI model as the local AI model of the UE;
training the local AI model using the local data;
generating the local AI model update information based on the training of the AI local model; and
in response to the generated local AI model update information being equal to or less than a preset reliability threshold, configuring not to transmit the first message to the base station.

10. A method of a base station, comprising:
transmitting an initial global artificial intelligence (AI) model for channel noise cancellation to each of user equipments (UEs) when the UEs initially access the base station;
transmitting preconfigured local data to the UEs;
receiving, from each of the UEs, a first message including local AI model update information;
generating a first global AI model by updating the initial global AI model based on the first messages; and
transmitting information on the first global AI model to the UEs,
wherein the first message includes at least one of information on the initial global AI model, the local AI model update information, or hyperparameters related to the initial global AI model and the local AI model.

11. The method according to claim 10, wherein the local data includes data and reference signals (RSs) preconfigured for training the local AI model.

12. The method according to claim 10, further comprising: receiving, from each of the UEs, a second message including additional information,
wherein the additional information includes at least one of information on a data transmission environment, transport block size (TBS) information, modulation coding scheme index (MCS) information, location information of each of the UEs, altitude information of each of the UEs, movement speed information of each of the UEs, trajectory information of each of the UEs, information on a movement of each of the UEs over time, quality of service (QoS) information, power information of each of the UEs, buffer information of each of the UEs, or UE capability information of each of the UEs.

13. The method according to claim 10, further comprising: receiving, from each of the UEs, a third message including performance monitoring information of a channel noise canceller using the first global AI model,
wherein the performance monitoring information includes at least one of a signal to interference plus noise ratio (SINR), a reference signal received power (RSRP), a hypothetical block error rate (BLER), throughput, or reliability information on an output of the channel noise canceller using the first global AI model.

14. The method according to claim 10, further comprising:
transmitting, to each of the UEs, downlink data corresponding to each of the UEs;
receiving, from each of the UEs, a feedback signal corresponding to the downlink data; and
in response to a preset number or more of the feedback signals including a negative acknowledgement (NACK), transmitting a fourth message instructing the UEs to stop using the first global AI model.

15. The method according to claim 14, wherein the fourth message further includes instruction information that instructs to perform training using the initial global AI model.

16. A user equipment (UE) comprising at least one processor, wherein the at least one processor causes the UE to perform:
configuring a local artificial intelligence (AI) model for channel noise cancellation of the UE based on an initial global AI model for channel noise cancellation;
training the local AI model using local data received from a base station;
generating local AI model update information based on the training of the local AI model;
transmitting, to the base station, a first message including the local AI model update information; and
receiving, from the base station, a first global AI model obtained by updating the initial global AI model,
wherein the first message includes at least one of information on the initial global AI model, the local AI model update information, or hyperparameters related to the global AI model and the local AI model.

17. The UE according to claim 16, wherein the information on the initial global AI model is received from the base station when the UE initially accesses the base station.

18. The UE according to claim 16, wherein the at least one processor further causes the UE to perform: transmitting, to the base station, a second message including additional information,
wherein the additional information includes at least one of information on a data transmission environment, transport block size (TBS) information, modulation coding scheme index (MCS) information, location information of the UE, altitude information of the UE, movement speed information of the UE, trajectory information of the UE, information on a movement of the UE over time, quality of service (QoS) information, power information of the UE, buffer information of the UE, or UE capability information of the UE.

19. The UE according to claim 16, wherein the at least one processor further causes the UE to perform: transmitting, to the base station, a third message including performance monitoring information of a channel noise canceller using the first global AI model,
wherein the performance monitoring information includes at least one of a signal to interference plus noise ratio (SINR), a reference signal received power (RSRP), a hypothetical block error rate (BLER), throughput, or reliability information on an output of a channel noise canceller using the first global AI model.

20. The UE according to claim 16, wherein the at least one processor further causes the UE to perform:
cancelling channel noise using the first global AI model when receiving data from the base station;
demodulating and decoding the data from which the channel noise has been cancelled;
feeding back a response signal based on a result of the demodulating and decoding to the base station; and
in response to receipt of an instruction to stop using the first global AI model from the base station. stopping use of the first global AI model.
